(19) United States
(12) Patent Application Publication
(10) Pub. No.: US 2005/0066480 A1
(43) Pub. Date: Mar. 31, 2005

(54) Band clamp

(75) Inventors: Jurgen Richter, Marsberg (DE); Jan Blazek, Hustopece (CS); Jan Sedlacek, (US)

Correspondence Address: OHLANDT, GREELEY, RUGGIERO & PERLE, L.L.P., ONE LANDMARK SQUARE, 10th FLOOR, STAMFORD, CT, 06901-2682, US

(73) Assignee: ABA OF SWEDEN AB

(21) Appl. No.: 10/811,166

(22) Filed: Mar. 26, 2004

Related U.S. Application Data
(63) Continuation of application No. 10/433,182, now abandoned.

(51) Int. Cl. F16L 33/00

(52) U.S. Cl. 24/20 R

(57) ABSTRACT

The invention relates to a band clamp (1) for connecting a hose or pipe end (2) to a pipe (3). Said band clamp comprises flange sections (4,5) which are located opposite each other and which are essentially radially set apart. The band clamp (1) is clamped around the connection on said flange sections, with means for preventing the band clamp material from creeping under stress being configured in the area of at least one of the flange sections (4,5). A sliding segment for preventing leaks is also provided.

The invention refers to a clamp for connecting the end of a flexible tubing or pipe to a pipe, this clamp having opposite-lying flange segments that stick out essentially radially and on which the clamp can be tightened around the connection.

Clamps of the type mentioned are commercially available. The opposite-lying flange segments are produced in one piece on the encircling clamp region through bending of the end of the clamping band. When the clamp is tightened around the connection, spreading of the band material can occur in that, for example, the clamp bends open in the region of the bend and the encircling region separates somewhat from the circumference of the flexible tubing or pipe. The consequence of this is that the tension of the clamp is reduced and the connection becomes loose.

The invention is based on the problem of designing a clamp of the type mentioned at a favorable cost of manufacture in such a way that it withstands the applied tension and retains its shape both during the tightening operation and in a permanently tensioned state.

The problem is solved, starting from a known clamp in accordance with the preamble of claim 1, through the characteristic features of claim 1.

The invention includes the technical teaching that, in the region of at least one of the flange segments, means to prevent the spreading of the clamp material during the tensioned state of the clamp are constructed. The means for preventing the spreading of the clamp material during the tensioned state of the clamp bring about a resistance that opposes the bending out of the radius between the encircling segment of the clamp and the flange segment that sticks out radially. Therefore, it is especially advantageous when the means for preventing spreading are arranged at least in part in the region of the angle between the encircling part of the clamp and the flange segment.

Advantageously, the means for preventing spreading are constructed as a rib. The rib-shaped construction of the means for preventing spreading result in an effective stiffening of the segments of the clamp that lie at an angle to one another in this critical region.

Advantageously, the rib can be molded as a bead into the clamp material. This achieves a method of manufacture that is favorable in terms of cost.

In an alternative embodiment, the rib can be designed as angle sheet iron, which can be fastened at each outer edge of the clamp in the case of narrow clamps or at any desired position in the case of broad clamps.

In a further embodiment, the means for preventing spreading can be made up of spot welds/weld seams, by means of which clamp components are fastened to the encircling clamping band. The change in material in the critical region of the bend results in a reinforcement of the material, so that, through these measures, a bending out of the bend is opposed.

Advantageously, the means for preventing spreading is constructed as a means to prevent rotation of the means of tightening that effects the tightening of the clamp. To this end, the ribs or beads can be arranged in the region of hole openings in the flange segment in such a way that an inserted bolt, which serves as a means of tightening, is held at its head in such a manner as to prevent rotation.

It is advantageous in the case of such clamps furnished with reinforcing plates on the flange segments that stick out radially to introduce into them a recess, into which the rib can enter, at the site of a rib.

It is advantageous in the case of a clamp whose means of tightening is made up of a bolt nut arrangement for there to be formed, on the shaft of the bolt, a polygon-for example, a square-that is accommodated in a correspondingly shaped recess in the flange sections in such a manner that it cannot rotate. Through this measure, it is ensured that the bearing region between the bolt and the flange sections is distributed in a linear manner or over a large area, in contrast to the usual, largely pointlike loads that have arisen up to now when a bolt of cylindrical cross section is inserted through a hole, also of circular cross section, in a flange.

In an embodiment of this kind, it is advantageous, moreover, for an undercut to be formed on the nut of the bolt nut arrangement to accommodate a region of the polygon. This undercut can be appropriate for the reason that the polygon should also extend through the hole of the opposite-lying flange segment, because, on this flange segment, too, the advantageous effect of a large-area bearing surface should be realized.

In the case of a clamp for connecting the end of a flexible tubing or pipe with the end of a pipe, this clamp having the mutually associated ends of an encircling clamping band, the clamp gap of which is covered with a saddle in the form of a sliding crosspiece, it can be advantageous when, on the saddle, those edges that interact with the clamping band in a sealing manner are furnished with a means for preventing leakage.

It can be advantageous to construct the means for preventing leakage as labyrinth seals. In this way, the counterpressure is increased and the leakage is reduced.

It is advantageous here when the edges and the edge of an associated impression in the clamping band have a labyrinth-like course.

In an alternative embodiment, the means for preventing leakage can be a plastically or elastically deformable sealing material, which is arranged in the form of a bead or rib along the edge of the saddle beneath the clamp material.

In a further alternative, the connection of the mutually associated ends of the flexible tubing or of the pipe can have a butt-jointed transition, wherein, at the site of the transition, a continuously encircling ring that projects radially inward is arranged.

The ring can, advantageously, be a bead that is impressed into the material of the clamp and of the saddle and is formed already in the press-drawing operation during manufacture.

The ring can also be a separately manufactured component that is made of a plastic or elastomeric material and applied subsequently.

The invention will be illustrated in greater detail below on the basis of various sample embodiments. Shown in the figures is the following:

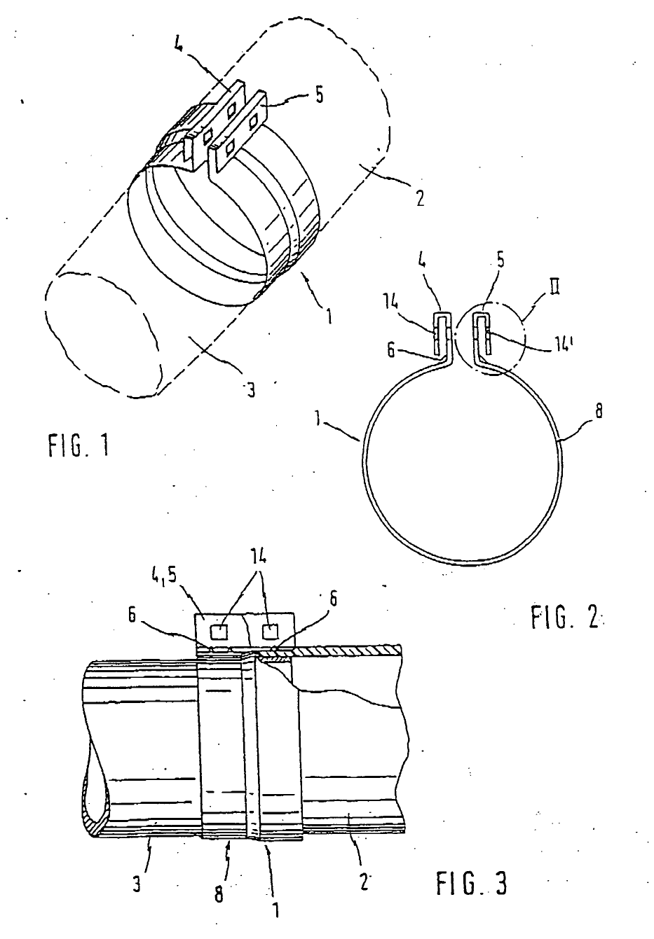

FIG. 1 a perspective view of a flexible tubing clamp in accordance with the invention, shown in perspective,
FIG. 2 a top view of the clamp of FIG. 1,
FIG. 3 a side view of the clamp of FIG. 1 with flexible tubing end and pipe end,

FIG. 4 a perspective partial representation of an angled region between a flange segment and a perimeter segment of the clamp,

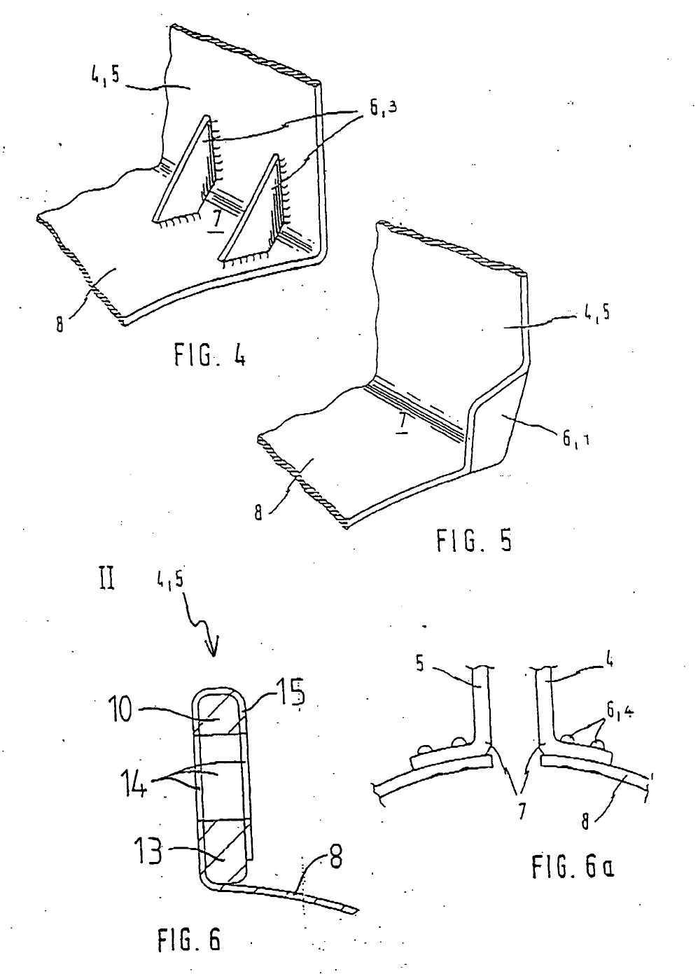

FIG. 5 a further embodiment corresponding to that in FIG. 4,

FIG. 6 an enlarged representation of the detail II of FIG. 2,

FIG. 6a an embodiment in which the means for preventing spreading are formed through weldings,

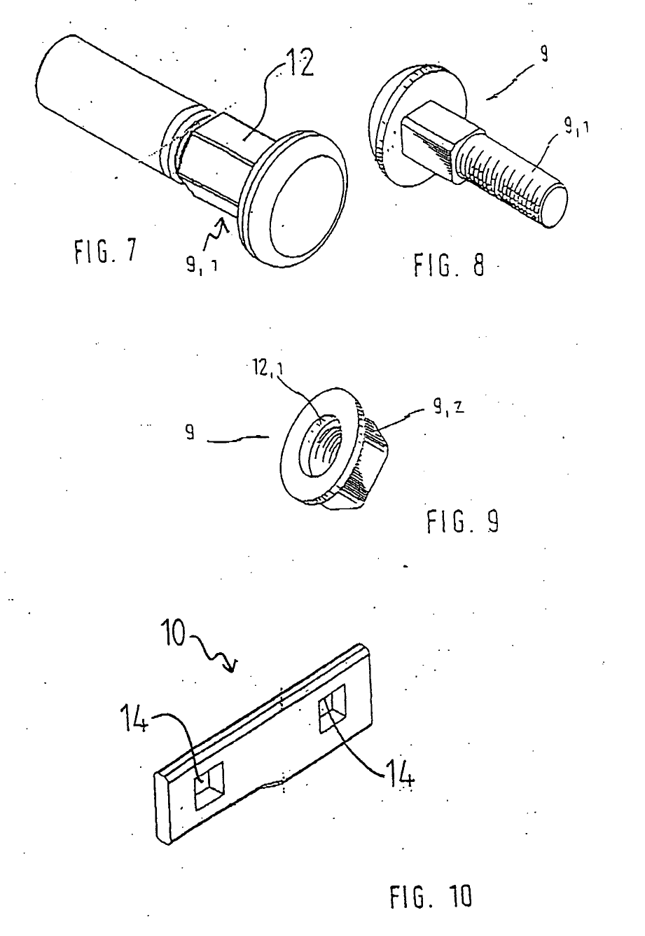

FIG. 7 a perspective representation of a means of fastening that has a polygon,

FIG. 8 a perspective representation of a further means of fastening in perspective representation,

FIG. 9 a perspective representation of a nut with an undercut,

FIG. 10 a perspective representation of a reinforcing plate,

FIG. 11 a perspective representation of a saddle with labyrinth edges,

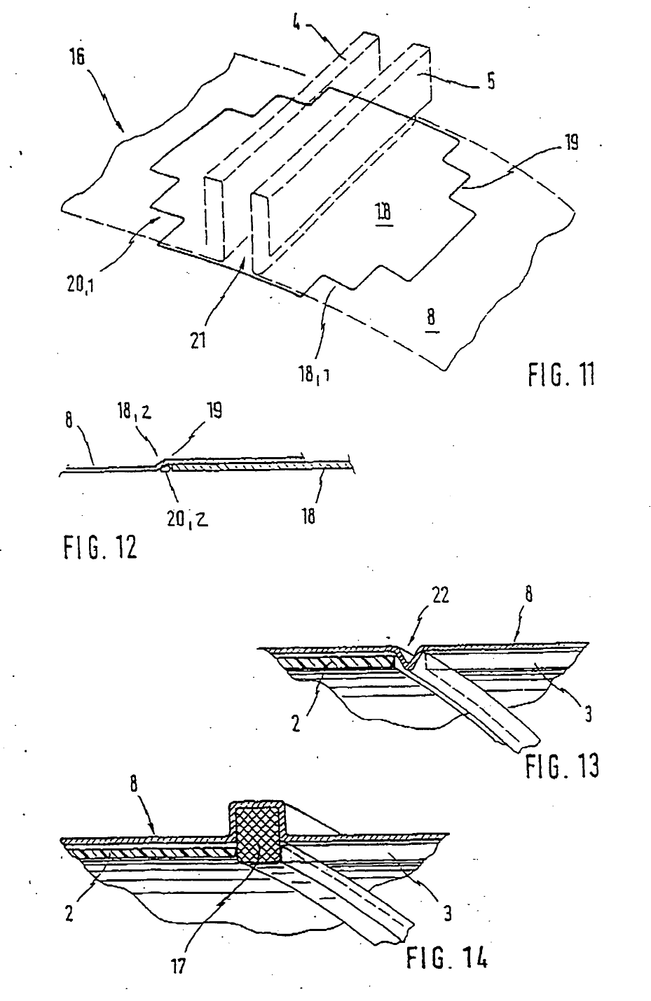

FIG. 12 a sectional representation of a partial region of the clamp with saddle and inlaid sealing bead,

FIG. 13 a perspective partial representation, in section, of a transition between the ends of a flexible tubing and a pipe with V-shaped bead,

FIG. 14 a perspective partial representation corresponding to FIG. 13, with a ring at the site of the bead, as well as

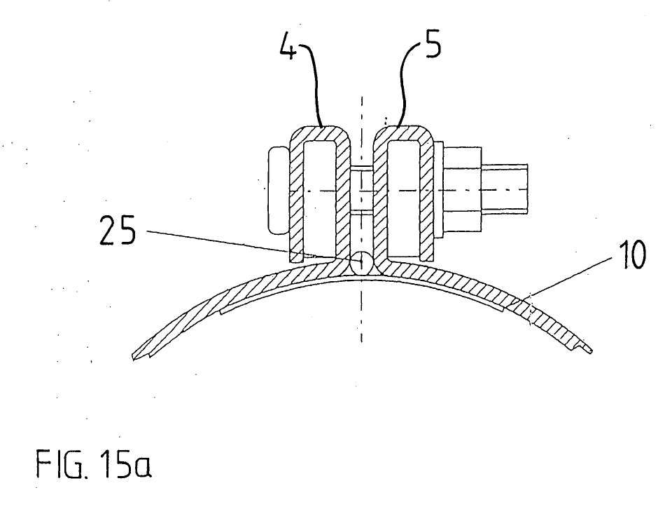

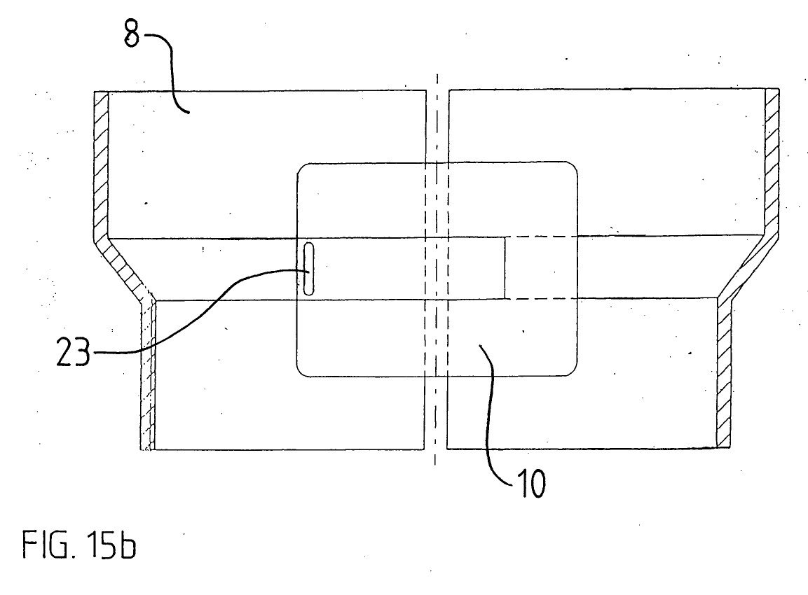

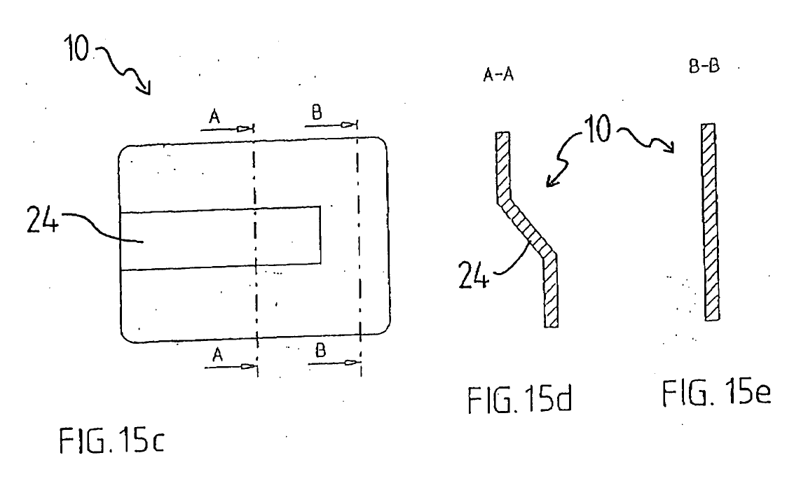

FIG. 15a-15e an alternative sample embodiment of a clamp in accordance with the invention.

FIG. 1 shows schematically a clamp 1 with flexible tubing end 2 and pipe end 3 shown in phantom representation. Shown schematically on the clamp 1 are flange segments 4 and 5, which serve to tighten the clamp.

FIG. 2 shows the clamp of FIG. 1 in plan view. In this representation, a detail II is marked, an enlargement of which is reproduced in FIG. 6. In the angled region between the clamping band 8 and the flange segment 4 or 5 is arranged a means 6 for preventing spreading.

Evident in FIGS. 1 and 2, as well as in FIG. 3, are square holes 14 in the flange segments 4, 5.

FIG. 3 shows, in side view and partially in sectional view, a clamp corresponding to that in FIG. 2, this clamp involving one in which the flexible tubing end 2 of large diameter is slid onto a pipe piece 3 of smaller diameter.

The means 6 for preventing spreading are particularly evident in the region of the pipe of smaller diameter, but they are also formed in the region of the clamp that encircles the larger diameter, namely, the segment in which the flexible tubing end overlaps the pipe.

Represented in FIG. 4 is a partial representation of the angled region 7 that is formed between the clamping band 8 and the flange segment 4 or 5. Fastened in this angled region 7 is the means for preventing spreading in the form of angle sheet iron 6.3. This welded construction presents itself, in particular, for clamps of larger diameter, in which the formation of a bead corresponding to the representation in FIG. 6 or a bend corresponding to the representation in FIG. 5 is not possible.

For the construction in accordance with FIG. 5, the means for preventing spreading is designed as a simple bending out 6.1 on the outer edge of the clamp.

FIG. 6 shows the detail II of FIG. 2, partially in section.

The radially projecting flange segment is bent radially outward in the angled region 7 of the clamping band 8 and, further, displays an additional double bending, designed in such a manner that free space for a reinforcing plate 10 is formed. Formed in the flange segment 4 or 5 is a hole 14 both in the angled clamp material and in the reinforcing plate 10.

The means of tightening are constructed as bolt-nut arrangements in the sample embodiments represented.

The final bend of the double bending of the flange segment 4 or 5 can terminate already in the upper region of the reinforcing plate 10 before the free end segment 13 has reached the region of the hole 14.

Represented in FIG. 6a is a further embodiment of the means for preventing spreading. In this alternative, the flange segment 4 is made up of a separate component, which is attached to the end segment of the clamp by means of spot welds 6.4. The welding, particularly at a site that is as close as possible to the radial leg of the angle 7, leads to a reinforcement of the radius region, this preventing or making difficult bending out or spreading.

FIG. 7 shows a perspective representation of a bolt. Formed on the bolt is a polygon, which, in the present case, is a hexagon 12. The hexagon 12 passes through the hole 14 in the flange segment 4 and 5, both through the material of the clamp and through the reinforcing plate. The construction of the polygon 12 can extend over a length in such a way that the two opposite-lying flange segments 4, 5 are penetrated by this polygon 12. In this way, it is ensured that, for the two flange segments 4, 5, a large-area bearing results on a corresponding surface of the polygon. Advantageously, the polygon consists of a square in such an orientation that the top-lying sides of the square run parallel to the axis of the clamp.

The use of a square or polygon on the bolt enables the head of the bolt 9.1 to be formed as a semicircle corresponding to a so-called carriage bolt.

Represented in FIG. 9 is a nut 9.2 as a component of the means of tightening 9. The nut 9.2 has an undercut 13.1, in which the region of the polygon 12 facing the thread of the bolt 9.1 can enter, if it comes out of the flange segment 4, 5 through the outer contour during clamping.

FIG. 10 shows the reinforcing plate 10 in perspective representation with the holes 14, the upper edges of which, 14′, run parallel to the central axis of the clamp. The lower edge of the reinforcing plate 10 is adjusted to fit to the step of the clamping band 8.

On account of the construction of the two reinforcing plates 10 in each of the flange segments 4 and 5, it is possible to attach from either side, as desired, the bolt nut arrangement for tightening the clamp. Each realization directed at a stiffening in the angled region between clamping band 8 and flange segment 4 or 5 that increases the dimensional stability in the region of sealing falls within the area of protection of the patent claims. For certain areas of application, a use of means of fastening furnished with a polygon is not desired. In this case, the bead or rib construction can be arranged at the angled region in such a way that this reinforcement serves, at the same time, to prevent rotation.

Represented in FIG. 11 is a plate-shaped sliding crosspiece 18, which covers the clamp gap 21 between the two flange segments 4 and 5. The edges 19 that lie beneath the clamping band 8 are furnished with a means for preventing leakage. In the sample embodiment represented, the means consist of a labyrinth seal arrangement 20.1. To this end, both the edges 19 and the edges 18.1 of the impressions 18.2 have a labyrinth-like course.

In a modification represented in FIG. 12, the means for preventing leakage is made up of a bead 20.2, which is laid on edge 19 of the saddle in the gap of the impression 18.2.

The connection of the ends of the flexible tubing 2 and the pipe 3 can be designed in an overlapping manner—that is, the flexible tubing 2 is slid onto the pipe 3 (see FIG. 3)—or as a butt-jointed transition, as represented in FIG. 13. Arranged here between the ends of the pipe 3 and the flexible tubing 2 is a continuously encircling ring 17 that projects radially inward. The respective ends abut, advantageously, the ring 17, which can be impressed into the clamping band as a bead 22.

In the alternative represented in FIG. 14, the ring 17 is made of a plastic or elastic material, which is held in the clamping band in a form-fitting manner. For special application purposes, the ring can also be made of metal or of another material.

FIGS. 15a to 15e show an alternative sample embodiment of a clamp in accordance with the invention that prevents leakage and agrees in large part with the embodiment represented in FIG. 11 and described above, so that, in the following discussion, the same reference numbers are used and, in order to avoid repetition, reference is made to the description above.

A special feature of this sample embodiment consists in the fact that the sliding crosspiece 10 does not have any lateral bars, but exhibits a nearly rectangular shape with rounded corners, as is evident, in particular, in FIG. 15c. Here, the sliding crosspiece 10 is centered in the region of the stepped impression and is attached on one side through a weld connection 23 to a free end of the clamping band 8.

Furthermore, the sliding crosspiece 10 is made of a deformable and thin material and has a thickness of only 0.2-0.3 mm, so that, when the clamp is tightened, the sliding crosspiece 10 lies so tightly against the clamping band 8 that practically no gap remains. A recess of the clamping band 8 for accommodating the sliding crosspiece 10 is therefore not required in this embodiment. Instead, the sliding crosspiece 10 retains its strength through the use of a high-strength material.

Here, the sliding crosspiece 10 has a stepped impression 24 on a part of the length of its perimeter, as is evident, in particular, in FIG. 15d, so that the sliding crosspiece 10 fits into the stepped impression of the clamping band 8. This stepped impression does not extend over the entire length of the perimeter of the sliding crosspiece 10, but, starting from the end with the welded connection.23, only over about 75% of the length of the perimeter of the sliding crosspiece 10. By contrast, the sliding crosspiece 10 is flat on its free end prior to assembly, as is evident, in particular, from the sectional representation in FIG. 15e. When the clamp is tightened, the flat segment of the sliding crosspiece 10 then molds tightly to the connection site between the flexible tubing, the flexible tubing connection piece, and the clamping band 8 under the effect of the tightening pressure. This makes it possible to compensate for the difference in tolerances between the flexible tubing and the connection piece.

Finally, in this sample embodiment, a round cord is laid between the two flange segments 4, 5, is immediately adjacent to the sliding crosspiece 10, and is preferably made of a material that is resistant to high temperature, such as, for example, glass fiber, the sealing of the connection being thereby improved still further.

The invention is not limited in its realization to the preferred sample embodiments given above. Equally conceivable are a number of variants that make use of the solution represented even for fundamentally different types of embodiments.

1. (Currently Amended) A clamp for connecting a first end of a flexible tubing or pipe to a second end of a pipe, comprising:
a clamping band configured to mate over said first and second ends;
opposite-lying flange segments extending substantially radially outward from said clamping band; and
means for preventing tension from spreading said clamping band said spreading prevention means being disposed in a region proximate at least one of said opposite-lying flange segments.

2. (Currently amended) The clamp in accordance with claim 1,
wherein said region is an angle defined between said clamping band and said opposite-lying flange segments.

3. (Currently amended) The clamp in accordance with claim 1,
wherein said spreading prevention means has at least one rib.

4. (Currently amended) The clamp in accordance with claim 3,
wherein said rib is a molded bead disposed at said region.

5. (Currently amended) The clamp in accordance with claim 3 wherein said rib is an angle sheet iron.

6. (Currently amended) The clamp in accordance with claim 3 wherein said rib is arranged on an outer edge of said clamping band.

7. (Currently amended) The clamp in accordance with claim 3 wherein said rib is secured to said clamping band by a weld.

8. (Currently amended) The clamp in accordance with claim 2,
wherein said spreading prevention means is a welded region for securing said opposite-lying flange segments to said clamping band.

9. (Currently amended) The clamp in accordance with claim 1 wherein said spreading prevention means is a rotation lock for tightening said clamping band on said first and second ends.

10. (Currently amended) The clamp in accordance with claim 1. wherein said opposite-lying flange segments have reinforcing plates.

11. (Currently amended) The clamp in accordance with claim 1 further comprising a bolt having a polygon portion formed on said bolt. said polygon portion being accommodated by a correspondingly formed hole in said opposite-lying flange segments in a manner that prevents rotation of said bolt.

12. (Currently amended) The clamp in accordance with claim 11, further comprising a nut for attachment to said bolt, said nut having an undercut for accommodating a region of said polygon portion.

13. (Currently amended) The clamp in accordance with claim 1, wherein said spreading prevention means is disposed on said opposite-lying flange segments.

14. (Currently amended) The clamp in accordance with claim 1, wherein said clamping band has two free ends defining a gap between said two free ends said gap being saddled by a sliding crosspiece.

15. (Currently amended) The clamp in accordance with claim 14, wherein said sliding crosspiece is essentially square.

16. (Currently amended) The clamp in accordance with claim 14. wherein said sliding crosspiece has a stepped impression.

17. (Currently amended) The clamp in accordance with claim 16, wherein said stepped impression, prior to assembly, extends only over a part of a perimeter of said sliding crosspiece, and wherein said sliding crosspiece, prior to assembly, is essentially flat along a remaining part of said perimeter.

18. (Currently amended) The clamp in accordance with claim 14, wherein said sliding crosspiece has a thickness of 0.2 mm to 0.3 mm.

19. (Currently amended) The clamp in accordance with claim 14, wherein said sliding crosspiece is made of a high-strength material.

20. (Currently amended) The clamp in accordance with claim 14, wherein said sliding crosspiece is made of a deformable material.

21. (Currently amended) The clamp in accordance with claim 1, further comprising a sealing element arranged between said opposite-lying flange segments.

22. (Currently amended) The clamp in accordance with claim 21, wherein said sealing element is strip-shaped.

23. (Currently amended) The clamp in accordance with claim 21, wherein said sealing element has a round cross section.

24. (Currently amended) The clamp in accordance with claim 21. wherein said sealing element is made of a material that is resistant to high temperature.

25. (Currently amended) The clamp in accordance with claim 23, wherein said sealing element is made of glass fiber.

26. (Currently amended) The clamp in accordance with claim 1, further comprising covering a clamping gap of said first and second ends defined between said opposite-lVing flange segments and a means for preventing leakage at intersecting edges of said saddle and said clamping band.

27. (Currently amended) The clamp in accordance with claim 26, wherein said means for preventing leakage is constructed as a labyrinth seal.

28. (Currently amended) The clamp in accordance with claim 26, wherein said intersecting edges and an edge of an associated impression in said clamping band have a labyrinth-like course.

29. (Currently amended) The clamp in accordance with claim 26, wherein said means for preventing leakage is a plastically or elastically deformable sealing material arranged along said intersecting edges.

30. (Currently amended) The clamp in accordance with claim 1, wherein said first and second ends have a butt-jointed transition having a continuously encircling ring arranged at said butt-jointed transition.

31. (Currently amended) The clamp in accordance with claim 30, wherein said continuously encircling ring is a bead impressed into said clamping band.

32. (Currently amended) The clamp in accordance with claim 30, wherein said continuously encircling ring is made of plastic or elastomeric material.

33. (Currently amended) The clamp in accordance with claim 26, further comprising a plastic or highly elastic sealing material is employed on said intersecting edges.
